(19) United States
(12) Patent Application Publication
(10) Pub. No.: US 2018/0018562 A1
(43) Pub. Date: Jan. 18, 2018

(54) PLATFORM FOR PROVIDING TASK BASED ON DEEP LEARNING

(71) Applicant: CSIDE JAPAN INC., Tokyo (JP)

(72) Inventor: Jinyeon JUNG, Seoul (KR)

(21) Appl. No.: 15/488,082

(22) Filed: Apr. 14, 2017

(30) Foreign Application Priority Data
Jul. 14, 2016 (KR) 10-2016-0089289
Jan. 19, 2017 (KR) 10-2017-0009236

(51) Int. Cl. G06N 3/08; G06F 17/30; G06F 17/27

(52) U.S. Cl. CPC G06N 3/08; G06F 17/2785; G06F 17/30312

(57) ABSTRACT

A platform for providing a task is provided based on a deep learning neural network. A method implemented by a computer includes extracting conversation information from at least one message application installed in an electronic device, extracting task information from the conversation information by using a convolutional neural network (CNN) learning model for natural language processing and a recurrent neutral network (RNN) learning model for creating a sentence, and providing the task information through a task providing application installed in the electronic device.

### CROSS-REFERENCE TO RELATED APPLICATIONS

A claim for priority under 35 U.S.C. §119 is made to Korean Patent Application No. 10-2016-0089289 filed Jul. 14, 2016, and Korean Patent Application No. 10-2017-0009236 filed Jan. 19, 2017, in the Korean Intellectual Property Office, the entire contents of which are hereby incorporated by reference.

### BACKGROUND

Embodiments of the inventive concept described herein relate to a platform service based on deep learning.

Today, as telecommunication networks such as the Internet and the like have been rapidly developed, messenger services have been generalized through the telecommunication networks.

A user may easily send and receive messages together with other users through the Internet, and such a messenger service has brought many changes in outer lives.

As mobile communication has been developed, the messenger service has been used as a public conversation way, which is free from national borders, in the form of a mobile messenger. The number of users of the messenger service is gradually increased, and services based on a messenger are gradually increased to keep up with the increase in the number of the users of the messenger service.

Such a messenger service enables a user to transmit information to another user in the form of a conversation.

As one example of a related art of the messenger service, there is provided Korean Unexamined Patent Publication No. 10-2004-0055027 (published on Jun. 26, 2004) disclosing a technology of implementing a messenger function in a portable terminal.

### SUMMARY

Embodiments of the inventive concept provide a task providing platform capable of extracting a task from conversation content, which is sent and received by a user, based on a deep neural network (DNN) and providing the task.

Embodiments of the inventive concept provide a task providing platform capable of extracting a task through natural language processing based on a DNN.

Embodiments of the inventive concept provide a leaning algorithm capable of exactly and effectively distinguishing between a task-related word and a task-unrelated word in conversation content.

Embodiments of the inventive concept provide a method of visualizing a task, capable of visualizing tasks extracted from conversation content, which is sent and received by a user, in a form that may be recognized by the user.

One aspect of embodiments of the inventive concept is directed to a method implemented by a computer. The method includes extracting conversation information from at least one message application installed in an electronic device, extracting task information from the conversation information by using a convolutional neural network (CNN) learning model for natural language processing and a recurrent neutral network (RNN) learning model for creating a sentence, and providing the task information through a task providing application installed in the electronic device.

According to an embodiment, the extracting of the task information may include extracting a core word corresponding to a task-related word from a sentence included in the conversation information through the CNN learning model in which the task-related word is learned, and creating a task sentence by using the core word through the RNN learning model.

According to an embodiment, the extracting of the task information may include analyzing a positive expression and a negative expression in a sentence included in the conversation information through the RNN learning model including a learning model specialized in analyzing emotion to create a confirmation sentence having no the negative expression, and extracting a core word corresponding to a task-related word from the confirmation sentence through the CNN learning model in which the task-related word is learned.

According to an embodiment, the extracting of the task information may include extracting a task, based on 5W1H (when, where, who, what, why, and how) attributes, from a sentence included in the conversation information through the CNN learning model in which a task-related word is learned.

According to an embodiment, the extracting of the task information may include analyzing a positive expression and a negative expression in a sentence included in the conversation information through a learning model specialized in analyzing emotion to reflect an analysis result of the positive and negative expressions on extraction of a task.

According to an embodiment, the CNN learning model may be constructed through learning performed by defining a target function based on a task-related word after words of learning data are expressed to a word vector through a word embedding scheme and by adjusting a distance between embedding vectors to distinguish between the task-related word and a task-unrelated word

According to an embodiment, the CNN learning model may be constructed through learning performed by defining a target function based on words which correspond to a place, time, and a goal and are included in the target-related word.

According to an embodiment, the CNN learning model and the RNN learning model may be reinforced through reinforcement learning models created by creating a cache model for learning data, which is added, when the learning data is added and then merging the cache model with an existing learning model.

Another aspect of embodiments of the inventive concept is directed to provide a computer program recorded in a computer-readable recording medium to perform a task providing method. The task providing method includes extracting conversation information from at least one message application installed in an electronic device, extracting task information from the conversation information by using a CNN learning model for natural language processing and an RNN learning model for creating a sentence, and providing the task information through a task providing application installed in the electronic device.

Still another aspect of embodiments of the inventive concept is directed to provide a system implemented with a computer. The system includes at least one processor implemented to execute a computer-readable instruction. The at least one processor may include a conversion extracting unit which extracts conversation information from at least one message application installed in an electronic device, a task extracting unit which extracts task information from the conversation information by using a CNN learning model for natural language processing and an RNN learning model for creating a sentence, and a task providing unit which provides the task information through a task providing application installed in the electronic device.

As described above, according to embodiments of the inventive concept, the task may be extracted from the conversation content, which is sent and received by the user, based on the DNN.

According to embodiments of the inventive concept, the task may be exactly extracted through the natural language processing having higher reliability due to the DNN.

According to embodiments of the inventive concept, the task-related word and the task-unrelated word in the conversation content may be exactly and effectively distinguished from each other.

According to embodiments of the inventive concept, the determination result for positive and negative sentences in the conversation may be reflected on the extraction of the task by applying a learning model specified in analyzing emotion, thereby exactly extracting an effective task.

According to embodiments of the inventive concept, when learning data is added to the learning model for extracting the task, the cache model is crated and merged with the existing model, thereby implementing a real-time learning process.

According to embodiments of the inventive concept, the task may be extracted and provided, based on the attributes of the 5W1H (When, Where, Who, What, Why, and How).

According to embodiments of the inventive concept, the tasks, which are extracted from the conversation content sent and received by the user, may be visualized in match with the optimized user interface (UI)/user experience (UX).

According to embodiments of the inventive concept, the task is automatically extracted from the conversation content and provided. Accordingly, it is possible to reduce time for thought and behaviors for determining or recording the schedule by the user without separately managing or memorizing tasks resulting from conversation.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a view illustrating an example of a network environment, according to an embodiment of the inventive concept;

FIG. 2 is a block diagram illustrating internal configurations of an electronic device and a server, according to an embodiment of the inventive concept;

FIG. 3 is a view illustrating components that may be included in a server for providing a platform service based on a DNN, according to an embodiment of the inventive concept;

FIG. 4 is a flowchart illustrating an example of a method which may be performed by a server for providing a platform service based on a DNN, according to an embodiment of the inventive concept;

FIG. 5 is a view illustrating an example of an LSTM learning model for task processing, according to an embodiment of the inventive concept;

FIG. 6 is a view illustrating a typical reinforcement learning process for deep learning;

FIG. 7 is a view illustrating a real-time reinforcement learning process, according to an embodiment of the inventive concept;

FIG. 8 is a view illustrating an example of a CNN learning model for extracting a task-related word, according to an embodiment of the inventive concept;

FIG. 9 is a view illustrating a procedure of creating a task sentence by using an LSTM model, according to an embodiment of the inventive concept;

FIG. 10 is a view illustrating a procedure of extracting a task, on which an analysis result of positive and negative expressions is reflected, according to an embodiment of the inventive concept; and

FIG. 11 is a view illustrating a procedure of extracting a task having 5W1H attributes, according to an embodiment of the inventive concept.

### DETAILED DESCRIPTION

Hereinafter, an embodiment of the inventive concept will be described with reference to accompanying drawings.

Embodiments of the inventive concept relate to a platform service based on deep learning, and more particularly, to a task providing platform capable of extracting a task from a conversation message and visualizing the task, based on a DNN.

According to embodiments including the specific disclosure of the specification, the platform service based on a DNN may be implemented, thereby extracting a task from confused conversations and visualizing the task. Further, significant advantages may be achieved in terms of efficiency, rationality, effectiveness, and cost reduction.

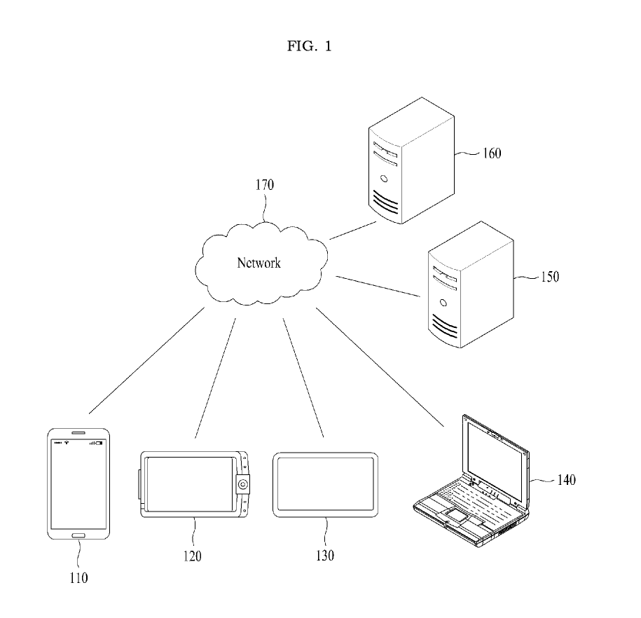

FIG. 1 is a view illustrating an example of a network environment, according to an embodiment of the inventive concept. The network environment of FIG. 1 represents an example of including a plurality of electronic devices 110, 120, 130, and 140, a plurality of servers 150 and 160, and a network 170. The network environment of FIG. 1 is provided for the illustrative purpose, and the number of the electronic devices or the number of the servers are not limited to those of FIG. 1.

The electronic devices 110, 120, 130, and 140 may be stationary terminals or mobile terminals implemented with computer devices. For example, the electronic devices 110, 120, 130, and 140 may include smart phones, cellular phones, navigation systems, computers, laptop computers, digital broadcast terminals, personal digital assistants (PDA), portable multimedia players (PMP), tablet personal computers, and the like. For example, a first electronic device 110 may make communication with the other electronic devices 120, 130, and 140 and/or the servers 150 and 160 through the network 170 in a wireless communication scheme or a wired communication scheme.

Various communication schemes may be provided and may include a short-range wireless communication scheme between devices as well as a communication scheme based on a telecommunication network (for example, a mobile communication network, a wired Internet, a wireless Internet, or a broadcasting network) which may be included in the network 170. For example, the network 170 may include at least one of predetermined networks such as a personal are network (PAN), a local area network (LAN), a campus area network (CAN), a metropolitan area network (MAN), a wide area network (WAN), a broadband network (BBN), and the Internet. In addition, the network 170 may include at least one of predetermined network topologies including a bus network, a star network, a ring network, a mesh network, a star-bus network, and a tree or hierarchical network, but the inventive concept is not limited thereto.

Each of the servers 150 and 160 may be implemented with a computer device or a plurality of computer devices which make communication with the electronic devices 110, 120, 130 and 140 through the network 170 to provide commands, codes, files, contents, or services. For example, a server 160 may provide a file for the installation of an application to the first electronic device 110 accessing the server 160 through the network 170. In this case, the first electronic device 110 may install an application using the file provided by the server 160. In addition, the first electronic device 110 may access the server 150 under the control of an operating system (OS) or at least one program (for example, a browser or the installed application) included in the first electronic device 110 and may receive the service or contents from the server 150. For example, if the first electronic device 110 transmits a message of requesting a service to the server 150 through the network 170 under the control of the application, the server 150 may transmit codes corresponding to the message of requesting the service to the first electronic device 110, and the first electronic device 110 configures and displays a screen based on the codes under the control of the application, thereby providing content for a user.

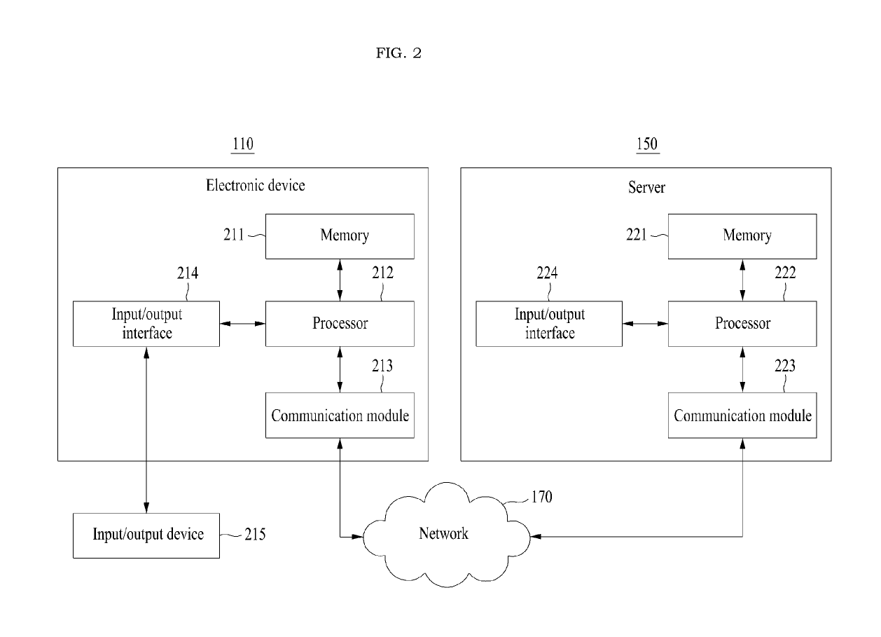

FIG. 2 is a block diagram illustrating internal configurations of an electronic device and a server, according to an embodiment of the inventive concept. In FIG. 2, the internal configurations of the first electronic device 110 and the server 150 will be representatively described. The other electronic devices 120, 130, and 140 or the server 160 may have the same internal configurations or similar internal configurations.

The first electronic device 110 and the server 150 may include memories 211 and 221, processors 212 and 222, communication modules 213 and 223, and input/output interfaces 214 and 224, respectively. The memories 211 and 221, which serve as computer-readable recording media, may include random access memories (RAMs), read only memories (ROM), and permanent mass storage devices, such as disk drives. In addition, the memories 211 and 221 may store OSs or at least one program code (for example, a code for a browser or a dedicated application installed in the first electronic device 110 to be run). Such software components may be loaded from a computer-readable recording medium separated from the memories 211 and 221. The computer-readable recording medium may include a floppy disk drive, a disk, a tape, a DVD/CD-ROM drive, or a memory card. According to another embodiment, software components may be loaded into the memories 211 and 221 through the communication modules 213 and 233 instead of the computer-readable recording medium. For example, at least one program may be loaded into the memories 211 and 221 based on a program (for example, the above-described application) installed by files provided by developers or a file distribution system (for example, the server 160), which distributes an install file of the application, through the network 170.

The processors 212 and 222 may be configured to process instructions of a computer program by performing basic arithmetic, logic, and input/output operations. The instructions may be provided to the processors 212 and 222 by the memories 211 and 221 or the communication modules 213 and 233. For example, the processors 212 and 222 may be configured to execute instructions received based on program codes stored in recording devices such as the memories 211 and 221.

The communication modules 213 and 233 may provide functions allowing the first electronic device 110 to make communication with the server 150 via the network 170, and may provide functions allowing the first electronic device 110 to make communication with another electronic device (for example, the second electronic device 120) or another server (for example, the server 160) via the network 170. For example, the processor 212 of the first electronic device 110 may transmit a request, which is created based on a program code stored in a recording device such as the memory 211, to the server 150 via the network 170 under the control of the communication module 213. Inversely, a control signal, an instruction, content, or a file provided under the control of the processor 222 of the server 150 may be received to the first electronic device 110 through the communication module 213 of the first electronic device 110 via the communication module 223 and the network 170. For example, the control signal or the instruction of the server 150 received through the communication module 213 may be transmitted to the processor 212 or the memory 211. The content or the file of the server 150 received through the communication module 213 may be stored in a storage medium which may be further included in the first electronic device 110.

The input/output interfaces 214 may be a unit which interfaces with an input/output device 215. For example, the input device may include a device such as a keyboard or a mouse, and the output device may include a device such as a display which displays a communication session of an application. According to an embodiment, the input/output interface 214 may be a unit which interfaces with a device such as a touch screen having one integrated function for input and output functions. In more detail, the processor 212 of the first electronic device 110 may display a service screen, which is configured using data provided by the server 150 or the second electronic device 120, or content on the display through the input/output interface 214 when the processor 212 of the first electronic device 100 processes instructions of a computer program loaded into the memory 211.

In addition, according to various embodiments, the first electronic device 110 and the server 150 may include components larger than those illustrated in FIG. 2 in number. However, mostly, it is not necessary to clearly illustrate components of the related art. For example, the first electronic device 110 may be implemented such that the first electronic device 110 includes at least a portion of the input/output device 215, or may further include a transceiver, a global positioning system (GPS) module, a camera, various sensors, or a database. In more detail, it may be understood that the first electronic device 110 further includes various components, such as an acceleration sensor, a gyro sensor, a camera, various physical buttons, buttons using a touch panel, an input/output port, and vibrators for vibration, which are included in a typical smartphone, when the first electronic device 110 is a smartphone.

Hereinafter, a method and a system for providing a platform service based on a DNN will be described.

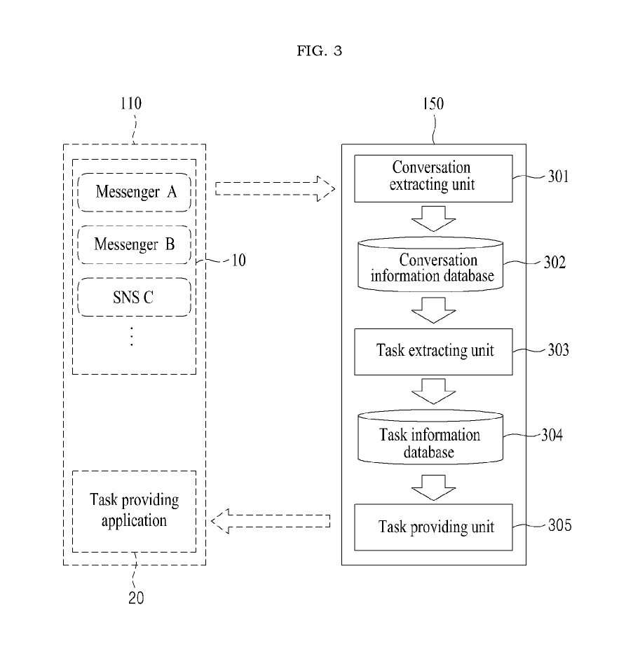

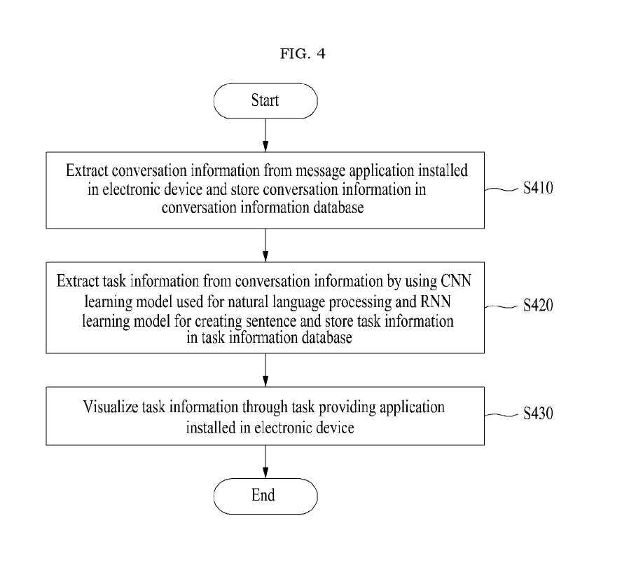

FIG. 3 is a view illustrating components that may be included in a server for providing the platform service based on the DNN, according to an embodiment of the inventive concept. FIG. 4 is a flowchart illustrating an example of a method which may be performed by the server for providing the platform service based on the DNN.

The server 150 serves as a platform which may automatically extract a task from a conversation message and may visualize the task, based on the DNN.

As illustrated in FIG. 3, components of the processor 222 of the server 150 may include a conversation extracting unit 301, a task extracting unit 303, and a task providing unit 305. The server 150 basically includes the components described with reference to FIG. 2. Further, the server 150, which serves as a big data platform for providing the platform service based on the DNN, may include a conversation information database 302, which stores conversation information extracted from the conversation extracting unit 301, and a task information database 304 which stores task information extracted from the task extracting unit 303.

The processor 222 and the components of the processor 222 may control the server 150 to perform operations 5410 to 5430 included in the method illustrated in FIG. 4. In this case, the processor 222 and the components of the processor 222 may be implemented to execute instructions based on codes of the OS and at least one program included in the memory 221. In addition, the components of the processor 222 may be expressions of mutually different functions performed by the processor 222 according to a control instruction provided by the OS or the at least one program. For example, the conversation extracting unit 301 may be used as a functional expression of the processor 222 which extracts conversation information according to the control instruction.

As illustrated in FIG. 3, the platform service provided by the server 150 is performed while interworking with media allowing a conversation between users through the Internet. In this case, the media may refer to message applications 10 which provides a service of sending and receiving a message in various formats such as a text, voice, a moving picture, and the like. The media may include an instant messenger, a social network service (SNS), an e-mail, a short message service (SMS), or a multi-media message service (MMS). For example, it may be natural that the message applications 10 may include various applications such as Kakao Talk, LINE, NATE ON, FACE BOOK, LINKED IN, and the like. The server 150 closely sends and receives information together with the message applications 10. To this end, the server 150 may provide additional services for a user. In other words, the server 150 may summarize a task extracted from the message application 10 and may provide information corresponding to the task.

In operation S410, the conversation extracting unit 301 may extract conversation information of a user of the first electronic device 110 from at least one message application 10 (for example, a messenger A, a messenger B, an SNS C, or the like) installed in the first electronic device 110 and may store the extracted conversation information in the conversation information database 302. In other words, the conversation extracting unit 301 may extract conversation information, which includes information on a talker making a conversation with a user and information on conversation content, from the message application 10 by using a software development kit (SDK) provided by a manufacturer of the message application 10. In this case, the conversation information extracted from the message application 10 may be accumulated into the conversation information database 302 which is a big data platform of a heterogeneous distribute system.

In operation S420, the task extracting unit 303 may extract task information from the conversation information, which is stored in the conversation information database 302, by using a convolutional neural network (CNN) learning model used for natural language processing and a recurrent neural network (RNN) learning model for creating a sentence and may store the task information in the task information database 304. In other words, the task extracting unit 303 may extract the task information from the conversation information by combining a CNN algorithm, which is used for extracting relevant words (task-related words) from the conversation content through the natural language processing, with an RNN algorithm which is used for creating a task sentence from the conversation content. The task extracting unit 303 may employ an algorithm of creating the task sentence by using the RNN learning model after performing pre-learning through the CNN learning model, or an algorithm of creating the task sentence by using the CNN learning model after extracting the task-related words by using the RNN learning model. According to the inventive concept, the task may be extracted and summarized with 5W1H attributes (When, Where, Who, What, Why, and How) through the DNN algorithm which is specialized in extracting task information to learn the task information. The task information extracted from the conversation information may be accumulated into the task information database 304 which is a big data platform of a heterogeneous distribute system. The learning model specialized in extracting the task information and a detailed procedure of extracting the task information will be described later.

In operation S430, the task providing unit 305 may provide the task information for a user of the first electronic device 110 by visualizing the task information through a task providing application installed in the first electronic device 110. The task providing unit 305 may perform a process of displaying tasks in real time through the task providing application by learning tasks accumulated in the task information database 304 and conversation information extracted from the message application in real time. In this case, the task providing application may include a personal computer (PC)-based program or an application dedicated for a mobile terminal. In addition, the task providing application may be implemented in the form of a program independently running or may be implemented to run on a specific application as the task providing application is configured in an In-App form of the specific application (for example, the message application). In other words, the task providing unit 305 may display the tasks, which are processed in real time through the task providing application provided in the form of a web service or an application dedicated for a mobile terminal, suitably for the optimized UI/UX.

The inventive concept has a feature implemented through a unique general artificial intelligence algorithm based on deep learning which enables the same thinking method as that of a human, and may employ a natural language processing technology and a task extracting algorithm. The natural language processing technology is a unique algorithm of learning the relationship between words through the DNN by utilizing an analysis technique for word expression to analyze a sentence and a phrase. In addition, the natural language processing technology is combined with an emotion analysis algorithm to not only analyze positive and negative expressions of a sentence, but also to detect and predict new words and typographical errors. Opinion mining, which is the emotion analysis algorithm, is a technique of analyzing the conversation content and providing useful information. According to the opinion mining, the text is analyzed, and the emotion and the opinion of a user who writes the text are made as statistic/numerical information to be changed to objective information. As the emotion analysis algorithm is applied, a positive expression and a negative expression of the conversation content, which is sent and received through the message application, may be analyzed and reflected when the task is extracted. In addition, the task extraction algorithm is an algorithm in which a huge amount of good-quality data is learned through the unique natural language processing technology, and machine self-determines a task establishment probability for the conversation content to autonomously and automatically construct a task dictionary while the machine is learning.

Hereinafter, the procedure of constructing a learning model specialized in extracting the task information will be described.

The server 150 may collect conversation messages, which are sent and received between users of the electronic devices 110, 120, 130, and 140, as learning data through message applications installed in the electronic devices 110, 120, 130, and 140 to construct the learning model specialized in extracting the task. A learning module (not illustrated), which is a component being able to be included in the processor 222 of the server 150, may construct the learning model specialized in extracting task information by using the learning data collected from the message applications used by several users.

1. The learning module may vectorize words by expressing words of the learning data in the form of a word vector.

A. The learning module may apply a word embedding scheme specialized in task distribution by using a Skip-Gram(N-Gram) model of word2vec, which is a machine learning model. For example, the learning module may learn task-related words, such as words corresponding to a place, time, and a goal, in a learning sentence.

Hereinafter, a procedure of distributing the place in the learning sentence will be described.

(1) Learning is performed after, for example, a sentence of “Let's have a beer in Gangnam” is set to a learning sentence.

(2) Noise samples in preset number are compared based on a noise distribution corresponding to a P(W) distribution which is a unigram (one word) distribution .

(3) It is assumed that a word of “in” of the learning sentence is selected as a noise word when the set noise number is set to ‘1’.

(4) In learning step t, a target function is defined as expressed in Equation 1 and primary learning is performed.

J_{NEG}^{(t)=log} Q_{θ}(D=1|′gangnam′; in′)+kE_{\tilde{w}˜P}_{ₙₒᵢₛₑ}[log Q_{θ}(D=0|′place;′ gangnam′)] Equation 1

In Equation, logQ₀ (D=1|w,h) denotes a binary logistic regression probability model which is to calculate a probability, in which a word ‘w’ comes from a context ‘h’ in a data set D, while learning an embedding vector Θ, and kE−_{w˜Pnoise} denotes K noise words in the noise distribution.

(5) The embedding vector Θ is updated to maximize the target function.

(6)

$$\overline{\frac{\partial }{\partial θ} {J}_{NEG}}$$

(a differential value of the target function corresponding to the value of the embedding vector Θ) is calculated to induce a gradient to the loss of the embedding vector Θ.

(7) The distance between embedding vectors is adjusted until a task-related word (‘Gangnam’ which is a word corresponding to a place in the learning sentence) is successfully distinguished from a task-unrelated word (‘in’ in the learning sentence).

A vector in the proximity of a word of a place may be acquired by adjusting the distances between the embedding vectors.

The goal and the time in the learning sentence may be distributed in the learning sentence through the procedures (1) to (7).

B. The learning module may adjust a clustering range and the gradient of task-related words. Table 1 illustrates an example that the clustering range and the gradient of the task-related words are adjusted.

TABLE 1

class TaskPredictor

def _init_(self):

self.vectorizer=Tfidvectorizer( )

def tran(self, data):

self.vectorizer.fit(np.append(data.context.values,
data.Utterance.values))

def predict(self, context, utterances):

vector_context=self.vectorizer.transform([context])
vector_doc=self f.vectorizer.transform(utterances)
result=np.dot(vector_doc, vector_context.T).todense( )
result=np.asarray(result).flatten( )
return np.argsort(result, axis=0) [::−1}

2. Learning algorithm

A. The learning module may employ a CNN algorithm for natural language processing, and the CNN learning model has the following structure.

(1) Vector values (Word2vec) of words in the learning sentence are arranged in the form of a matrix at an input layer of a CNN learning model.

(2) A convolution layer having multiple filters is linked with a max-pooling layer.

(3) A Softmax classifier is selected at a classification layer.

B. The learning module may employ the RNN algorithm having the following structure to create a sentence. The RNN algorithm has the following structure.

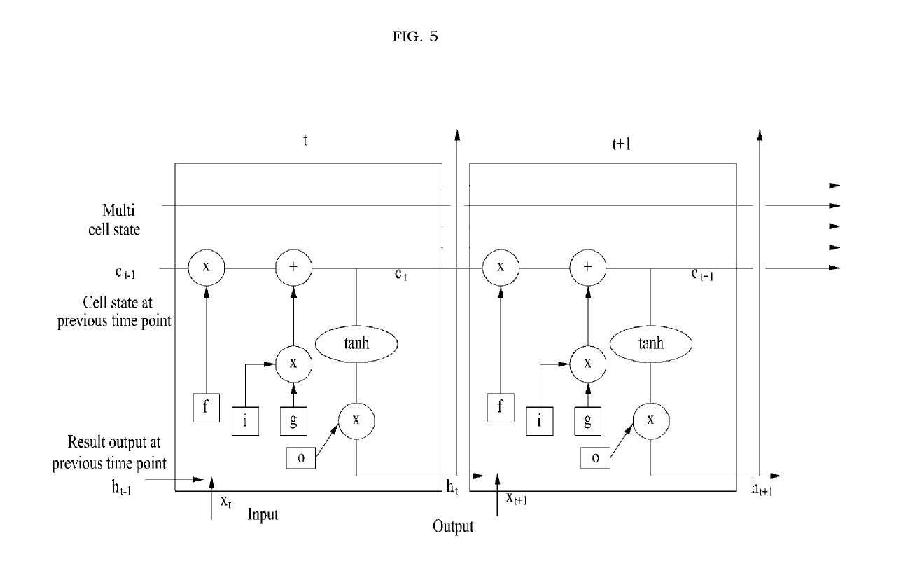

(1) A RNN learning model employs a long-term short-term (LSTM) model (see FIG. 5) for task processing.

(2) The RNN learning model may be to determine whether a learning sentence is a positive sentence or a negative sentence based on the context of the learning sentence. The algorithm of determining whether the learning sentence is the positive sentence or the negative sentence is expressed in Equation 2.

$$f ( {h}_{i} ) = {W}_{2} tanh ( {W}_{1} {h}_{i} + {b}_{1} ) \\ {a}_{i} = {e}^{f ( {h}_{i} )} / {\sum }_{j = 1}^{n} {e}^{f ( {h}_{j} )} \\ c = {\sum }_{k = 1}^{n} {a}_{k} {h}_{k} \qquad Equation 2$$

In Equation 2, ‘h’ denotes a vector value representing an output of a hidden layer, ‘w’ denotes a weight vector value used to find an attention, ‘b’ denotes a bias, ‘e’ denotes an exponential function, and ‘a’ denotes a weight for a positive expression or a negative expression, that is, a weight of ‘h’ when ‘c’ (context vector) is found.

C. The learning module may employ real-time reinforcement learning processing for the learning data.

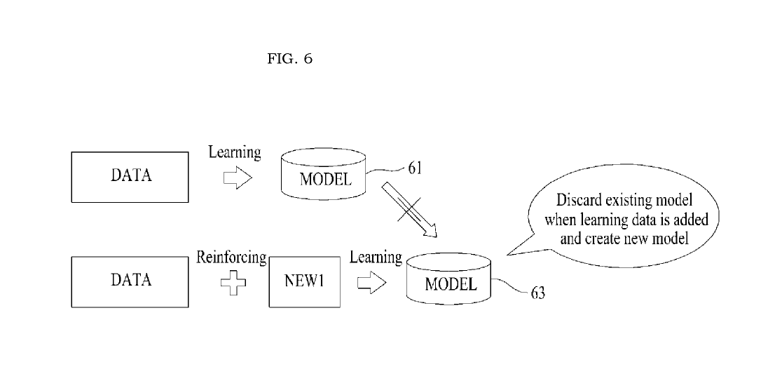

(1) A typical reinforcement learning process for deep learning has a structure of creating a learning model 61 (a CNN learning model and an RNN learning model) by learning learning data as illustrated in FIG. 6. When learning data is added thereafter, the reinforcement learning process is performed to discard the existing learning model 61 and to learn whole learning data including new data, thereby creating a new learning model 63.

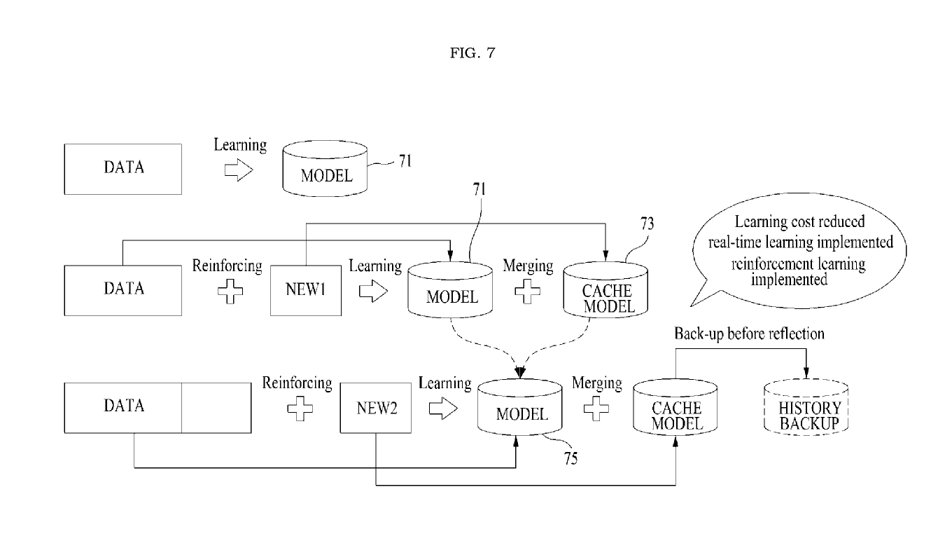

(2) The real-time reinforcement learning process may implement a real-time learning process by creating a cache model and merging the cache model with the existing learning module. Referring to FIG. 7, the learning data is learned to create a learning model 71. Thereafter, when learning data is added, a cache model 73 is created with respect to the added learning data, and is merged with the existing learning model 71 to create a reinforcement learning model 75. Accordingly, a real-time learning process and a reinforcement learning process are implemented with respect to the learning model by utilizing the cache model, thereby reducing resources and costs necessary for constructing the learning model.

To extract detailed task information, a learning algorithm of extracting task information is as follows.

1. The task extracting unit 303 may employ an algorithm (CNN+RNN learning algorithms) of performing pre-learning through the CNN learning model and then of creating a task sentence through an RNN learning model.

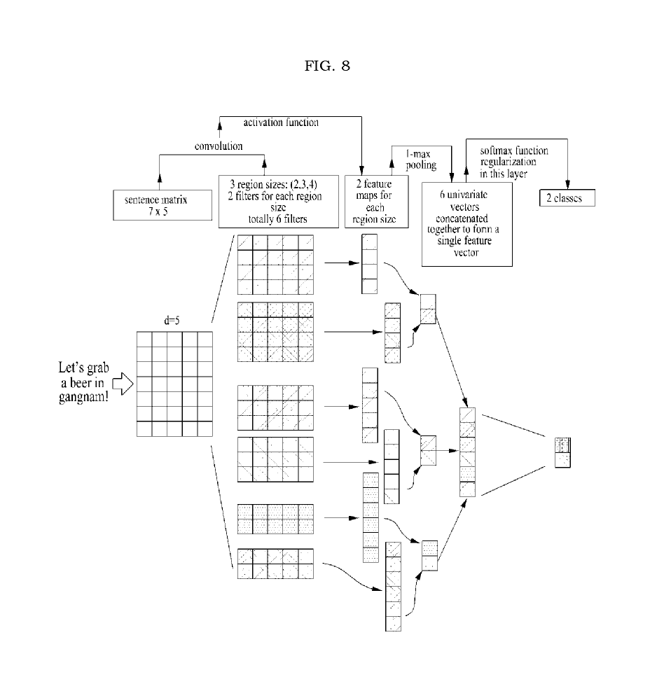

A. The task extracting unit 303 may extract a task-related word, which is a core word, from a sentence using the CNN learning model (see FIG. 8).

(1) A word included in the sentence is embedded as a vector value.

(2) A convolution is performed with respect to three filters (having the lengths of rows set to 2, 3, and 4) and the total six sentence matrixes to create feature maps.

(3) The maximum value is extracted by performing Max-Pooling for each map.

(4) Six univariate feature vectors (Max-pooling result values) are linked to feature vectors at a classification layer (Softmax classifier).

(5) Task-related words (words according to places, goals, and times) are extracted through the classification layer (Softmax classifier).

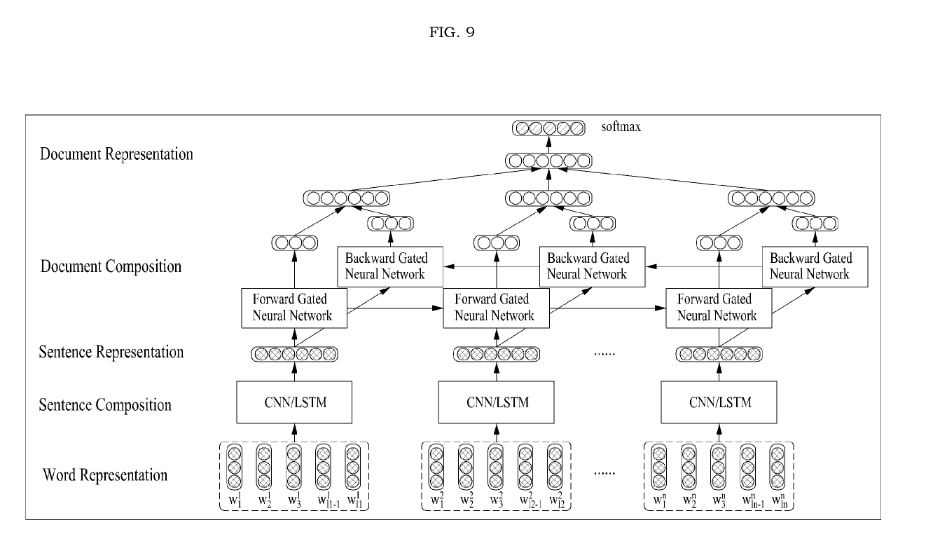

B. The task extracting unit 303 may create a task sentence using an LSTM which is the RNN learning model. The task extracting unit 303 may learn words selected through the CNN learning model as input data of the RNN learning model. In this case, the task extracting unit 303 may correct words such as a spoken word or a slang word. FIG. 9 is a view illustrating an RNN learning model having words, which are selected based on the CNN learning model, as input data.

(1) A word representation layer: Vector values of the words (including a spoken word or a slang word) selected based on the CNN learning model are arranged in time-series.

(2) A sentence composition layer: The vector values input at the word representation layer are re-created to sentences through the LSTM algorithm.

(3) A sentence representation layer: Sentences created at the sentence composition layer are arranged.

(4) A document composition layer: Non-learned data (spoken words or slang words) in the created sentence are substituted with words having the closest meaning (is determined using combination of vector values in a similar sentence) in the sentence of the learned conversation.

(5) A documentation representation layer: The final sentence is selected from the sentences including the substituted words by using a Softmax function.

2. The task extracting unit 303 may employ an algorithm (RNN+CNN learning algorithm) of extracting the task-related word based on the RNN learning model and then creating a task sentence based on the CNN learning model.

A. The task extracting unit 303 may summarize the flow of a conversation using the RNN learning model.

(1) The task extracting unit 303 may detect a positive meaning and a negative meaning of the sentence by employing a learning model specialized in analyzing emotion. The model specialized in analyzing the emotion may be defined as expressed in Equation 3.

z=σ(W₂xₜ+U₂hₜ₋₁+b_{z})

r=σ(Wᵣxₜ+Uᵣhₜ₋₁+b_{z})

m=act(Wₘxₜ+Uₘ(hₕ₋₁∇r)+bₘ)

hₜ=(1−z)∇hₜ₋₁+z∇m Equation 3

In Equation 3, σ̅ denotes a sigmoid function, xt denotes the input of a previous sequence, hₜ₋₁ denotes the output of the previous sequence, each of W_{z}, U_{z}, Wᵣ, Uᵣ, Wₘ, Uₘ denotes a weight matrix for a gate and a cell memory, ‘r’ denotes a reset gate used to determine the ratio at which a previous state is reflected on an input of the unit, ‘z’ denotes an update gate of determining a reflection degree by conserving a previous state, ‘act’ denotes an activation function, ‘∇̅’ denotes an element-wise product.

(2) The task extracting unit 303 may determine the range of a context affected by a negative word.

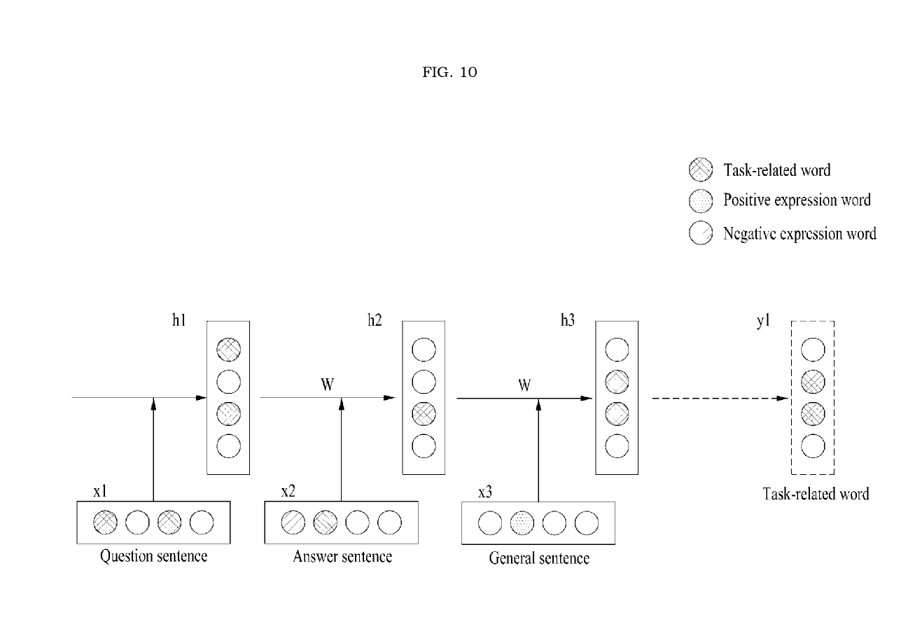

(3) Referring to FIG. 10, the task extracting unit 303 may create a task confirmation sentence by combining task-related words including positive expression words after excluding negative expression words from the task-related words. In other words, the positive expression word is valid as the task-related word, but the negative expression word is excluded from the task-related words.

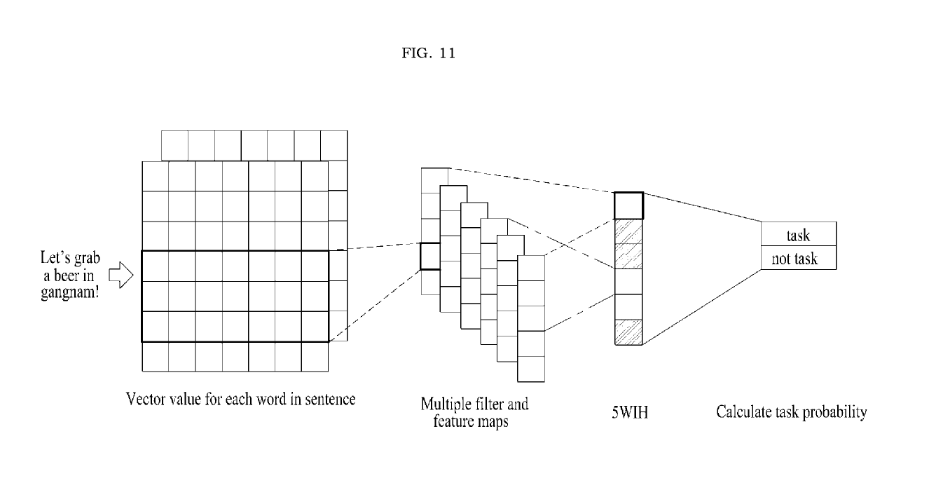

B. The task extracting unit 303 may determine the final task sentence by calculating a task probability after extracting the task-related words with 5W1H attributes (When, Where, Who, What, Why, and How) using the CNN learning model. FIG. 11 illustrates a CNN learning model of extracting a task with the 5W1H attributes.

(1) Vector values of words in a sentence are arranged in a matrix. Although FIG. 11 illustrates that the vector values in a six dimension for the convenience of illustration, the vector values are actually provided in 100 dimensions or more.

(2) A convolution-transformation is performed using multiple filters.

(3) Max-Pooling is performed with respect to the convolution result by using 5W1H feature maps.

(4) A task probability is calculated through Max-Pooling.

For example, the task extracting unit 303 may determine a sentence, which has a task probability equal to or greater than a set value among task confirmation sentences, as the final task sentence by applying the CNN learning model to each task confirmation sentence created through the RNN learning model.

For example, a learning algorithm according to the inventive concept may be implemented through Hadoop+Hbase, Spark+Word2vec, Tensorflow+Theano+Kerar, or the like.

For example, according to the inventive concept, a method of extracting a task for a platform service based on a DNN may include a data collection step, a data normalization step, a data classification step, and a pattern mining step.

The data collection step is a procedure of collecting all available data including conversation content sent and received through a message application by accessing the message application used by a user.

The data normalization step is a procedure of quantifying a text of the collected data using Word2Vec, which is one of Spark M1lib functions, and of converting the quantified data to a vector value (numeric value). In other words, a word expression is converted to a value that may be expressed in a vector space through a neural network. Word2Vec is an algorithm of determining proximity based on the relationship between front and rear words and is an unsupervised learning algorithm based on deep learning. The Word2Vec has advantages in that a word dictionary is not required due to unsupervised learning and new words, old words, and slang may be easily extracted.

The data classification step is a procedure of classifying data representing a vector trait similar to that of a common data cluster. In other words, data having a similar pattern and a similar trait are clustered and classified. For example, clustering for words, which correspond to a place, a goal, and time in a sentence, is possible.

The pattern mining step is a procedure of recognizing the same vector pattern frequently generated in the common data cluster. It is possible to learn information used to extract a task from the conversation content based on the recognized pattern.

As the natural language processing technology is combined with the algorithm, the task may be extracted from the conversation content. First, a huge amount of data is learned through the natural language processing technology. Next, the task establishment probability is self-determined with respect to the conversation content and a task dictionary is autonomously and automatically constructed while learning is performed. Through the learning model, the task may be extracted from the conversation content on various message applications used by a user. The natural language processing may correspond to an algorithm of omitting modifying task words in Word2vec and of performing correcting non-learning data (slang, spoken words, or the like) of all words through the RNN.

As described above, according to the embodiments of the inventive concept, the task is extracted from the conversation content sent and received by the user and visualized based on the DNN. Accordingly, it is possible to reduce time for thought and behaviors for determining or recording the schedule by the user without separately managing or memorizing tasks resulting from conversation. In addition, according to embodiments of the inventive concept, the natural language processing technology having higher reliability is applied to extract the task from the conversation content, thereby exactly and effectively distinguishing between the task-related word and the task-unrelated word. In addition, according to embodiments of the inventive concept, the determination result for positive and negative sentences in the conversation may be reflected on the extraction of the task by applying a learning model specified in analyzing emotion, thereby exactly extracting an effective task. Further, according to embodiments of the inventive concept, when learning data is added to the learning model for extracting the task, the cache model is crated and merged with the existing model, thereby implementing a real-time learning process. Accordingly, the resources and the costs necessary for constructing the learning model may be reduced.

The foregoing devices may be realized by hardware components, software components and/or combinations thereof. For example, the devices and components illustrated in the embodiments of the inventive concept may be implemented in one or more general-use computers or special-purpose computers, such as a processor, a controller, an arithmetic logic unit (ALU), a digital signal processor, a microcomputer, a field programmable gate array (FPGA), a programmable logic unit (PLU), a microprocessor or any device which may execute instructions and respond. A processing unit may perform an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing components and/or a plurality of types of processing components. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner Software and data may be recorded in one or more computer-readable storage media.

The methods according to the above-described embodiments of the inventive concept may be implemented with program instructions which may be executed through various computer means and may be recorded in computer-readable media. The media may be to persistently store, execute, or temporarily store a computer-executable program for the downloading thereof. The media may various recording means or storage means formed by single hardware or formed the combination of several hardware. The media is not limited to media directly connected with a certain computer system, but distributed over a network. The media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. In addition, the media may include an App store, which distributes an application or recording media or storage media managed in a site or a server which supplies or distributes.

While a few embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned components, such as systems, structures, devices, or circuits, are combined or coupled in different forms and modes than as described above or be substituted or switched with other components or equivalents.

Therefore, those skilled in the art can easily understand that various implementations, various embodiments, and equivalents shall be construed within the scope of the inventive concept specified in attached claims.

What is claimed is:

1. A method implemented by a computer, the method comprising:
extracting conversation information from at least one message application installed in an electronic device;
extracting task information from the conversation information by using a convolutional neural network (CNN) learning model for natural language processing and a recurrent neutral network (RNN) learning model for creating a sentence; and
providing the task information through a task providing application installed in the electronic device.

2. The method of claim 1, wherein the extracting of the task information includes:
extracting a core word corresponding to a task-related word from a sentence included in the conversation information through the CNN learning model in which the task-related word is learned; and
creating a task sentence by using the core word through the RNN learning model.

3. The method of claim 1, wherein the extracting of the task information includes:
analyzing a positive expression and a negative expression in a sentence included in the conversation information through the RNN learning model including a learning model specialized in analyzing emotion to create a confirmation sentence having no the negative expression; and
extracting a core word corresponding to a task-related word from the confirmation sentence through the CNN learning model in which the task-related word is learned.

4. The method of claim 1, wherein the extracting of the task information includes:
extracting a task, based on 5W1H (when, where, who, what, why, and how) attributes, from a sentence included in the conversation information through the CNN learning model in which a task-related word is learned.

5. The method of claim 1, wherein the extracting of the task information includes:
analyzing a positive expression and a negative expression in a sentence included in the conversation information through a learning model specialized in analyzing emotion to reflect an analysis result of the positive and negative expressions on extraction of a task.

6. The method of claim 1, wherein the CNN learning model is constructed through learning performed by defining a target function based on a task-related word after words of learning data are expressed to a word vector through a word embedding scheme and by adjusting a distance between embedding vectors to distinguish between the task-related word and a task-unrelated word.

7. The method of claim 6, wherein the CNN learning model is constructed through the learning performed by defining the target function based on words which correspond to a place, time, and a goal and are included in the target-related word.

8. The method of claim 1, wherein the CNN learning model and the RNN learning model are reinforced through reinforcement learning models created by creating a cache model for learning data, which is added, when the learning data is added and then merging the cache model with an existing learning model.

9. A computer program recorded in a computer-readable recording medium to perform a task providing method,
wherein the task providing method includes:
extracting conversation information from at least one message application installed in an electronic device;
extracting task information from the conversation information by using a CNN learning model for natural language processing and an RNN learning model for creating a sentence; and
providing the task information through a task providing application installed in the electronic device.

10. A system implemented with a computer, the system comprising:
at least one processor implemented to execute a computer-readable instruction,
wherein the at least one processor includes:
a conversion extracting unit configured to extract conversation information from at least one message application installed in an electronic device;
a task extracting unit configured to extract task information from the conversation information by using a CNN learning model for natural language processing and an RNN learning model for creating a sentence; and
a task providing unit configured to provide the task information through a task providing application installed in the electronic device.
